(19) United States
(12) Patent Application Publication
(10) Pub. No.: US 2022/0308313 A1
(43) Pub. Date: Sep. 29, 2022

(54) FOCUS ADJUSTMENT DEVICE, FOCUS ADJUSTMENT METHOD, AND IMAGE CAPTURE APPARATUS

(71) Applicant: CANON KABUSHIKI KAISHA, Tokyo (JP)

(72) Inventors: Kouki Yamashita, Tokyo (JP); Kengo Takeuchi, Kanagawa (JP); Makoto Yokozeki, Kanagawa (JP)

(21) Appl. No.: 17/699,285

(22) Filed: Mar. 21, 2022

(30) Foreign Application Priority Data
Mar. 24, 2021 (JP) 2021-050386

(51) Int. Cl. G02B 7/36; H04N 5/232

(52) U.S. Cl. CPC G02B 7/36; H04N 5/23212; G03B 13/36

(57) ABSTRACT

A focus adjustment device that controls driving of a focus lens included in a lens unit during moving image shooting, is disclosed. The device obtains a drive pattern determined in advance for driving the focus lens to an in-focus position and controls the driving of the focus lens. If the drive pattern has a fine-driving section in which it is necessary to drive the focus lens at a drive speed less than a minimum drive speed set in advance, and it is determined that the lens unit not to be suitable for fine driving of the focus lens, the device continuously drives the focus lens at the minimum drive speed in the fine-driving section.

### BACKGROUND OF THE INVENTION

### Field of the Invention

The present invention relates to a focus adjustment device, a focus adjustment method, and an image capture apparatus.

### Description of the Related Art

In an image capture apparatus having an autofocus function that automatically drives a focus lens, if the drive speed of the focus lens changes significantly while recording a moving image, the focus condition of the moving image may change suddenly and give an unnatural impression. According to Japanese Patent Laid-Open No. 2018-36509, sudden changes in the drive speed of a focus lens are suppressed by ensuring not to change from a mode in which the drive speed of the focus lens is constant to a mode in which the drive speed of the focus lens is variable, until a defocus amount becomes less than a predetermined value.

To control the focus condition to change smoothly, it is necessary to drive the focus lens at a low speed when near an in-focus state. On the other hand, the weight of the focus lens, the drive mechanism, and the like vary depending on the lens unit. Accordingly, delay between when a drive command for the focus lens is transmitted and when the focus lens actually starts moving, as well as the change in the drive speed of the focus lens, also vary depending on the lens unit. As such, even if drive control appropriate for one lens unit is applied to another lens unit, it may not be possible to realize the desired drive speed.

### SUMMARY OF THE INVENTION

The present invention in one aspect provides a focus adjustment device, a focus adjustment method, and an image capture apparatus capable of suppressing differences in changes in focus conditions due to differences in lens units by performing appropriate focus lens drive control depending on a respective lens unit.

According to an aspect of the present invention, there is provided a focus adjustment device that controls driving of a focus lens included in a lens unit during moving image shooting, the focus adjustment device comprising one or more processors that execute a program and thereby function as: an obtainment unit that obtains a drive pattern determined in advance for driving the focus lens to an in-focus position; and a control unit that controls the driving of the focus lens, wherein if the drive pattern has a fine-driving section in which it is necessary to drive the focus lens at a drive speed less than a minimum drive speed set in advance, and it is determined that the lens unit not to be suitable for fine driving of the focus lens, the control unit continuously drives the focus lens at the minimum drive speed in the fine-driving section.

According to another aspect of the present invention, there is provided an image capture apparatus comprising: a defocus amount obtainment unit that obtains a defocus amount of a lens unit that is mounted; and a focus adjustment device that drives a focus lens included in the lens unit based on the defocus amount, wherein the focus adjustment device comprising: an obtainment unit that obtains a drive pattern determined in advance for driving the focus lens to an in-focus position; and a control unit that controls the driving of the focus lens, wherein if the drive pattern has a fine-driving section in which it is necessary to drive the focus lens at a drive speed less than a minimum drive speed set in advance, and it is determined that the lens unit not to be suitable for fine driving of the focus lens, the control unit continuously drives the focus lens at the minimum drive speed in the fine-driving section.

According to a further aspect of the present invention, there is provided a focus adjustment method executed by a focus adjustment device for controlling driving of a focus lens having a lens unit during moving image shooting, the focus adjustment method comprising: obtaining a drive pattern determined in advance for driving the focus lens to an in-focus position; and controlling the driving of the focus lens, wherein when the drive pattern has a fine-driving section in which it is necessary to drive the focus lens at a drive speed less than a minimum drive speed set in advance, and the lens unit is determined not to be suitable for fine driving of the focus lens, the controlling includes continuously driving the focus lens at the minimum drive speed in the fine-driving section.

According to another aspect of the present invention, there is provided a non-transitory computer-readable medium storing a program that causes a computer to function as a focus adjustment device comprising: an obtainment unit that obtains a drive pattern determined in advance for driving the focus lens to an in-focus position; and a control unit that controls the driving of the focus lens, wherein if the drive pattern has a fine-driving section in which it is necessary to drive the focus lens at a drive speed less than a minimum drive speed set in advance, and it is determined that the lens unit not to be suitable for fine driving of the focus lens, the control unit continuously drives the focus lens at the minimum drive speed in the fine-driving section.

Further features of the present invention will become apparent from the following description of exemplary embodiments (with reference to the attached drawings).

### BRIEF DESCRIPTION OF THE DRAWINGS

FIG. 1 is a block diagram illustrating an example of the functional configuration of a camera system serving as an example of an image capture apparatus including a focus adjustment device according to an embodiment.

FIG. 2 is a flowchart pertaining to overall operations.

FIG. 3 is a flowchart pertaining to startup processing indicated in FIG. 2.

FIG. 4 is a flowchart pertaining to AF processing indicated in FIG. 2.

FIG. 5 is a flowchart pertaining to base curve calculation processing indicated in FIG. 4.

FIG. 6 is a diagram illustrating the base curve calculation processing indicated in FIG. 4.

FIG. 7 is a flowchart pertaining to drive control processing indicated in FIG. 4.

FIGS. 8A and 8B are flowcharts pertaining to drive mode determination processing indicated in FIG. 4.

FIG. 9 is a flowchart pertaining to focus trajectory calculation processing indicated in FIG. 4.

FIG. 10 is a flowchart pertaining to drive mode A processing.

FIG. 11 is a flowchart pertaining to drive mode B processing.

FIG. 12 is a flowchart pertaining to drive mode C processing.

FIG. 13 is a diagram illustrating drive mode determination processing.

FIG. 14 is a flowchart pertaining to drive mode D processing.

FIG. 15 is a diagram illustrating drive mode determination processing.

FIGS. 16A and 16B are flowcharts pertaining to drive mode E processing.

FIG. 17 is a diagram illustrating focus trajectory calculation processing in drive mode E.

FIGS. 18A and 18B are flowcharts pertaining to drive mode determination processing in a second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Note that the following embodiments will describe a case where the present invention is applied in an interchangeable lens-type digital video camera. However, the present invention can be applied in any electronic device that can capture moving images using different types of lens units. Examples of such an electronic device include video cameras, computer devices (personal computers, tablet computers, media players, PDAs, and the like), mobile phones, smartphones, game consoles, robots, drones, and dashboard cameras. These are merely examples, however, and the present invention can be applied in other electronic devices as well.

### First Embodiment

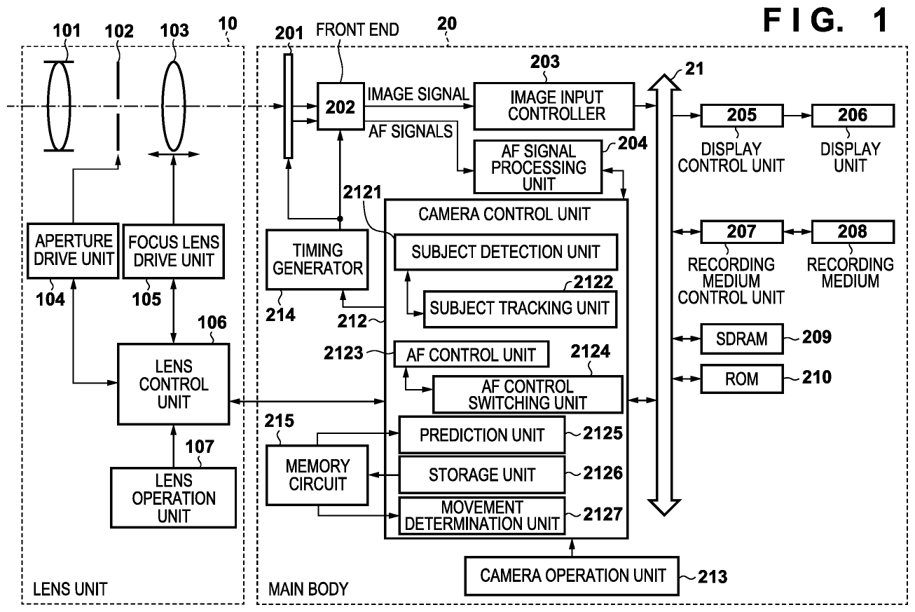

A first embodiment of the present invention will be described. FIG. 1 is a block diagram illustrating an example of the functional configuration of a camera system serving as an example of an image capture apparatus including a focus adjustment device according to a first embodiment of the present invention.

The camera system is an interchangeable lens-type video camera system, and is constituted by a main body 20, which serves as the image capture apparatus according to the present embodiment, and a lens unit 10 that can be attached to and detached from the main body 20. The main body 20 and the lens unit 10 are mechanically and electrically connected through respective mount units. A camera control unit 212 in the main body 20 and a lens control unit 106 in the lens unit 10 can send and receive information, commands, and the like by communicating through the mount units.

The configuration of the lens unit 10 will be described first. A fixed lens 101, an aperture stop 102, and a focus lens 103 constitute an optical imaging system. The aperture stop 102 is driven by an aperture drive unit 104, and controls the amount of light incident on an image sensor 201 (described later). The focus lens 103 is driven along an optical axis by a focus lens drive unit 105 constituted by a DC motor and a control circuit thereof. The focus distance of the imaging optical system changes according to the position of the focus lens 103.

The lens control unit 106 controls operations of the aperture drive unit 104 and the focus lens drive unit 105 according to the commands from the camera control unit 212, and controls the amount by which the aperture stop 102 is open and the position of the focus lens 103. The drive control of the focus lens (described later) is also realized by the lens control unit 106 controlling the focus lens drive unit 105 according to commands from the camera control unit 212. The lens control unit 106 also transmits information pertaining to the lens unit, stored in non-volatile memory of the lens control unit 106, information pertaining to the position of the focus lens, and the like to the camera control unit 212.

“Lens operation unit 107” is a collective term for a group of input devices provided in the lens unit. The lens operation unit 107 includes a switch for changing between AF (autofocus) and MF (manual focus) mode, a focus ring, an aperture ring, a focus limiter, a switch for changing an image stabilization mode, and the like. These are merely examples and are not required, input devices having other functions assigned may be included as well. The operation of the lens operation unit 107 are detected by the lens control unit 106, and the lens control unit 106 performs control according to the detected operation.

The lens control unit 106 has, for example, a CPU, ROM, and RAM, and controls each part in the lens unit 10, communicates with the camera control unit 212, and so on by loading programs stored in the ROM into the RAM and executing the programs.

The configuration of the main body 20 will be described next. The image sensor 201 is a CMOS image sensor, for example, in which pixels having photodiodes formed therein are arranged two-dimensionally. The optical imaging system of the lens unit 10 forms an optical image of a subject on an image formation surface of the image sensor 201. In each pixel of the image sensor 201, the photodiode generates an electric charge in response to the amount of incident light and generates a pixel signal that converts the amount of charge into a voltage.

Pixel signals are read out sequentially in, for example, units of pixel lines, by drive pulses output by a timing generator 214 in response to commands from the camera control unit 212. The series of processing is repeatedly executed, using a period in which pixel signals are read out from all effective pixels in the image sensor 201 as a camera control period.

Also, the image sensor 201 used in the present embodiment is assumed to be capable of generating a parallax signal pair for implementing image plane phase detection AF. For example, each pixel includes one microlens and two photodiodes A and B, and the photodiodes A and B are configured to receive light fluxes from different partial regions of the exit pupil of the optical imaging system, respectively. For a plurality of pixels in a focus detection region, an A image signal, obtained by concatenating the A signals read out from the photodiode A, and a B image signal, obtained by concatenating the B signals read out from the photodiode B, form a parallax signal pair. By detecting a phase difference of this parallax signal pair and converting the phase difference into a defocus amount and a defocus direction of the optical imaging system, the position of the focus lens can be driven to an in-focus position.

Note that a normal pixel signal (A+B signal) can be obtained by adding the signals from the photodiodes A and B for each pixel. Normal pixel signals are used to generate image data, and are therefore also called “captured image signals”. In contrast, the A signal and the B signal are used for automatic focus detection (autofocus) and are therefore also called “AF signals”.

A front end 202 performs correlated double sampling, gain adjustment, and AD conversion for removing reset noise on the signal read out from the image sensor 201. The front end 202 outputs these processed signals to an image input controller 203 and an AF signal processing unit 204, according to the type of signal. Specifically, the front end 202 outputs the A+B signal to the image input controller 203, and the A signal and B signal to the AF signal processing unit 204. The AF signal may be read out only from pixels within a preset focus detection region, or from all pixels.

Note that if the A signal and the A+B signal are read out from the image sensor and the B signal is not read out, the front end 202 outputs a difference between the A+B signal and the A signal as the B signal to the AF signal processing unit 204. Likewise, if the B signal and the A+B signal are read out from the image sensor and the A signal is not read out, the front end 202 outputs a difference between the A+B signal and the B signal as the A signal to the AF signal processing unit 204.

The image input controller 203 applies predetermined image processing to the captured image signal output from the front end 202 and generates image data for display and image data for recording. The predetermined image processing includes color interpolation, white balance adjustment, various types of correction, scaling, encoding, and the like.

The image input controller 203 stores the generated image data in SDRAM 209 via a bus 21. The image data for display stored in the SDRAM 209 is read out by a display control unit 205 via the bus 21 and displayed in a display unit 206. The image data for recording stored in the SDRAM 209 is read out by a recording medium control unit 207 and recorded into a recording medium 208 such as a semiconductor memory card.

The camera control unit 212 is, for example, a CPU that realizes the functions of the camera system as a whole by loading programs stored in ROM 210 into the SDRAM 209 and executing the programs, and controlling the main body 20 and the lens unit 10. In the figure, the function blocks of the camera control unit 212 are schematic illustrations of functions realized by the camera control unit 212 executing programs. Note that some of the functions realized by the camera control unit 212 executing programs may be implemented by hardware circuits such as ASICs or the like.

The ROM 210 is, for example, electrically rewritable non-volatile memory. The ROM 210 stores the programs executed by the camera control unit 212, various data necessary for executing the programs, various setting values, unique information of the main body 20, and the like.

A subject detection unit 2121 in the camera control unit 212 detects a region pertaining to a specific subject (subject region) from the image data stored in the SDRAM 209, and obtains the position and size of the detected subject region. The subject detection unit 2121 also detects movement of the subject region between frames. The specific subject is, for example, the face of a person or animal, or a region that has a high degree of similarity to a partial region in the screen specified by the user in the camera operation unit 213.

A subject tracking unit 2122 is used to track the subject region across frames in cases where the subject region detected by the subject detection unit 2121 is set as the focus detection region. The subject tracking unit 2122 detects the subject region using a different method from that of the subject detection unit 2121, such as using color information, for example.

The AF signal processing unit 204, which serves as a focus detection device, generates the A image signal and the B image signal from the A signal and the B signal output from the front end 202, and calculates an amount of image shift (phase difference) between the A image signal and the B image signal, as well as a reliability of the amount of image shift. The amount of image shift can be calculated by shifting the A image signal and the B image signal relative to each other, obtaining a correlation amount, and then calculating an amount of shift where the correlation is the highest. The reliability can be calculated based on the correlation amount corresponding to the amount of image shift, the steepness of a change in the correlation amount near the amount of image shift, contrast signals of the A image signal and the B image signal, and the like. The method of calculating the amount of image shift, the reliability thereof, and the like are not particularly limited, and any publicly-known method can be used.

The generation of the A image signal and the B image signal, and the calculation of the amount of image shift and the reliability thereof, may be executed for a plurality of regions in the screen. For example, in a case such as where AF signals are obtained over the entire screen, the AF signal processing unit 204 can set the focus detection region based on the amount of image shift, and the reliability thereof, obtained for a plurality of regions.

The AF signal processing unit 204 outputs information on the amount of image shift obtained for the focus detection region, and the reliability thereof, to the camera control unit 212. An AF control unit 2123 in the camera control unit 212 converts the amount of image shift calculated by the AF signal processing unit 204 into a defocus amount. Then, the AF control unit 2123 transmits, to the lens control unit 106, a lens drive command including a drive amount and a drive direction of the focus lens determined based on the defocus amount. The lens control unit 106 drives the focus lens 103 by controlling the focus lens drive unit 105 based on the lens drive command. Through this, the focus of the optical imaging system is adjusted such that the focus detection region is in focus.

An AF control switching unit 2124 switches an operating mode of the AF control unit 2123 based on a determination result from a movement determination unit 2127, an operation made in the camera operation unit 213, and the like.

A prediction unit 2125 predicts the next position for focus detection based on a change in the defocus amount over time. The prediction unit 2125 can be used for the subject tracking function.

A storage control unit 2126 stores various information pertaining to drive control of the focus lens, including information indicating a drive pattern (drive characteristics) of the focus lens according to the defocus amount obtained for the focus detection region, in a memory circuit 215. The memory circuit 215 may be a region in the SDRAM 209.

The movement determination unit 2127 estimates an amount of movement of the focus lens based on a relationship between an amount of movement of the focus lens 103 instructed to the lens control unit 106 and an actual amount of movement. The AF control unit 2123 controls operations of the AF control switching unit 2124, the storage control unit 2126, and the movement determination unit 2127.

In the above configuration, the AF signal processing unit 204 and the camera control unit 212 constitute a focus adjustment device according to the embodiment.

The following will describe, in detail, autofocus operations in the main body 20 when shooting a moving image. The moving image shooting may be moving image shooting for display (e.g., moving image shooting for causing the display unit 206 to function as an EVF), or moving image shooting for recording.

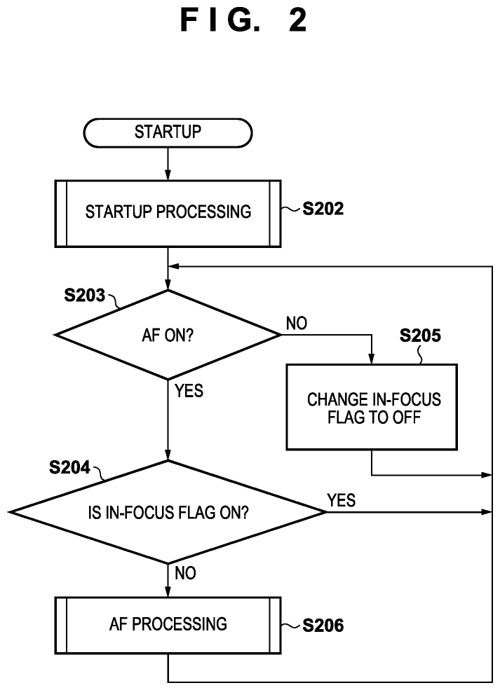

FIG. 2 is a flowchart illustrating operations of the main body 20 from startup, from the perspective of autofocus operations.

When startup is instructed by a power switch of the camera operation unit 213 being operated or the like, the camera control unit 212 executes startup processing in step S202.

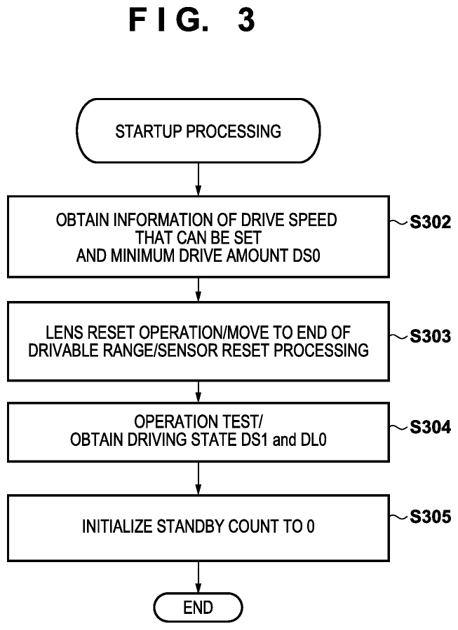

The startup processing will be described with reference to the flowchart in FIG. 3. The camera control unit 212 first checks whether the lens unit 10 is mounted. Here, it is assumed that the lens unit 10 is mounted.

In step S302, the camera control unit 212 obtains lens information by communicating with the lens control unit 106. The lens information includes type information, control period, drive speed information, and minimum drive amount information. The type information is information that can identify the product, such as a model name of the lens unit 10. The control period is the repetition period of control operations of the lens unit. The drive speed information indicates a drive speed of the focus lens that can be set in the lens unit 10. The drive speed of the focus lens depends on the weight of the focus lens, the performance of the drive mechanism, and the drive control method, and can vary depending on the model of the lens unit 10. The minimum drive amount information indicates a minimum drive amount DS0 of the focus lens.

When the main body 20 specifies the drive speed of the focus lens to the lens unit 10, the speed indicated in the drive speed information is specified. Additionally, when specifying the drive amount of the focus lens, a drive amount that is not less than the minimum drive amount DS0 is specified. The focus lens will not move even if a drive amount less than the minimum drive amount DS0 is specified.

For example, assume that the drive amount for the focus lens is expressed as a number of drive pulses, and the minimum drive amount DS0 is 120 pulses. In this case, even if a drive command specifying 100 pulses as the drive amount is transmitted to the lens control unit 106, the focus lens will not move.

In step S303, the camera control unit 212 performs a reset operation for the lens unit 10. Specifically, the camera control unit 212 drives the focus lens 103 to the end of its physical drivable range, and then resets a sensor that measures the position of the focus lens. This resets position information of the focus lens.

In step S304, the camera control unit 212 performs an operation test for the focus lens. Specifically, the camera control unit 212 sets a minimum drive speed among the drive speeds indicated by the drive speed information and a first target drive amount for measuring the actual minimum drive amount, and transmits a focus lens drive command to the lens control unit 106. The first target drive amount may be, for example, the minimum drive amount DS0 obtained from the lens unit 10, but another drive amount may be used. Upon receiving a response to the command from the lens control unit 106, the camera control unit 212 obtains the actual amount of movement of the focus lens from the lens control unit 106. The camera control unit 212 stores the actual amount of movement relative to the first target drive amount as movement amount information DS1, in the memory circuit 215, for example.

The effect of gravity on the focus lens 103 changes depending on the shooting attitude, and particularly the angle in the vertical direction of the optical axis. In addition, variations in the assembly accuracy, component tolerances, and the like exist in the lens unit 10. On the other hand, the minimum drive amount DS0 obtained from the lens unit 10 is a design value that assumes specific conditions. Accordingly, the minimum drive amount in a real environment can be different from DS0. The actual drive amount is therefore measured when the lens unit operation is reset. The movement amount information DS1 may be obtained by converting the actual amount of movement obtained for a first target drive amount which is slightly larger than DS0.

Next, the camera control unit 212 sets the minimum drive speed and a second target drive amount defined as greater than the first target drive amount, and transmits a focus lens drive command to the lens control unit 106. The second target drive amount is defined in order to measure error in the drive amount when the focus lens 103 is moved significantly. The camera control unit 212 then obtains the actual amount of movement, and stores a difference between the second target drive amount and the actual drive amount as drive amount information DLO in, for example, the memory circuit 215.

The camera control unit 212 then drives the focus lens back to a default position after the reset operation. This completes the operation test.

In step S305, the camera control unit 212 initializes a standby count to 0 and ends the startup processing. The standby count is a variable that is referenced in processing for extending a real control period. The standby count will be described later.

Returning to FIG. 2, once the startup processing ends, the camera control unit 212 executes processing in a shooting standby state. The camera control unit 212 controls each unit such that the display unit 206 functions as an electronic viewfinder (EVF) by, for example, continuously executing moving image recording, generation of the image data for display, and displaying in the display unit 206 based on the image data for display.

In step S203, the camera control unit 212 determines whether autofocus is active. The camera control unit 212 executes step S204 if autofocus is set to be active through a menu screen or the lens operation unit 107, and executes step S205 if autofocus is set to be inactive (manual focus).

In step S205, the camera control unit 212 sets a “in-focus” flag stored in the memory circuit 215 or the SDRAM 209, for example, to “off” (e.g., 0), and executes step S203 again.

In step S204, the camera control unit 212 determines whether the “in-focus” flag is on (e.g., 1). If the “in-focus” flag is on, there is no need to perform AF processing, and thus the camera control unit 212 skips step S206 and executes step S203. On the other hand, if the “in-focus” flag is off, the camera control unit 212 executes AF processing in step S206.

In this manner, in step S203 to step S206, for each control period, the camera control unit 212 executes AF processing when autofocus is set to active and the camera is not in the in-focus state.

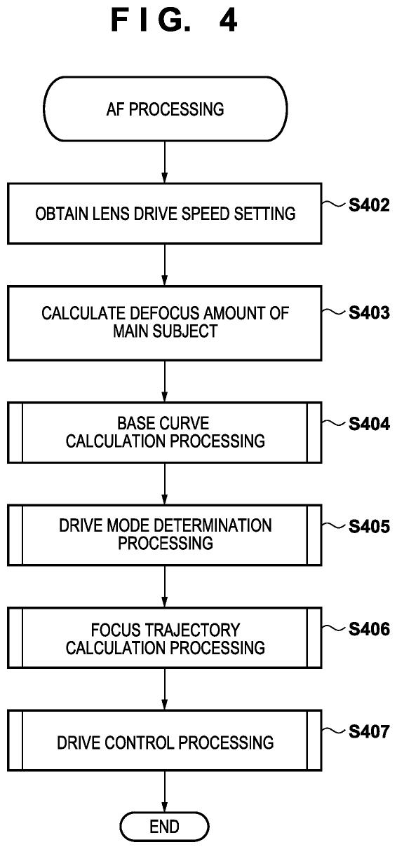

The AF processing performed in step S206 of FIG. 2 will be described next in further detail with reference to the flowchart in FIG. 4.

In step S402, the camera control unit 212 obtains a lens drive speed setting from the ROM 210, for example. The lens drive speed setting can be set by the user by operating a menu screen using the camera operation unit 213, for example. In later processing, the drive speed of the focus lens is determined based on the lens drive speed setting.

In step S403, the camera control unit 212 obtains the defocus amount by causing the AF signal processing unit 204 to detect the amount of image shift for a main subject region. The main subject region may be a focus detection region specified by the user, or may be a region, in the subject region detected by the subject detection unit 2121, having a position, size, or the like that meet predetermined conditions.

Subject tracking processing is realized by searching the main subject region over a plurality of frames of a moving image. The following will describe AF processing in which the main subject region is used as the focus detection region, and the focus lens is driven to bring the main subject region into focus.

In step S404, the camera control unit 212 calculates a curve expressing focus lens drive characteristics serving as a reference (a base curve) based on the defocus amount calculated for the main subject region.

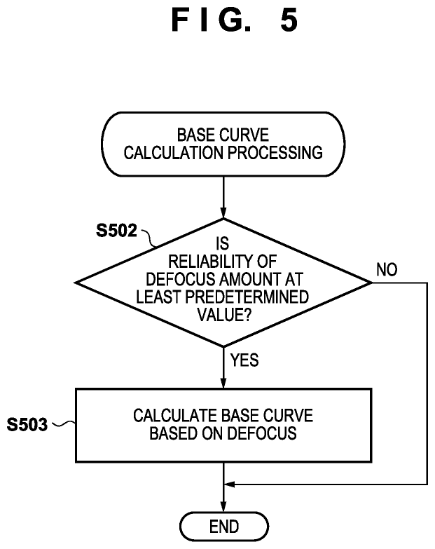

FIG. 5 is a flowchart pertaining to the base curve calculation processing in step S404.

In step S502, the camera control unit 212 determines whether the reliability of the defocus amount of the main subject is at least a predetermined value. This determination may be made by comparing a reliability obtained from the AF signal processing unit 204 as the reliability of the amount of image shift used to calculate the defocus amount with the predetermined value. The camera control unit 212 executes step S503 if the reliability of the defocus amount is determined to be at least the predetermined value, and ends the base curve calculation processing if the reliability of the amount of image shift is determined not to be at least the predetermined value.

In step S503, the camera control unit 212 calculates the base curve based on the defocus amount calculated in step S402. The camera control unit 212 calculates the base curve based on reference drive characteristics stored in the memory circuit 215 and the defocus amount calculated in step S402. The base curve indicates how to drive the focus lens in each control period, from the current position of the focus lens until the focus lens reaches the in-focus position.

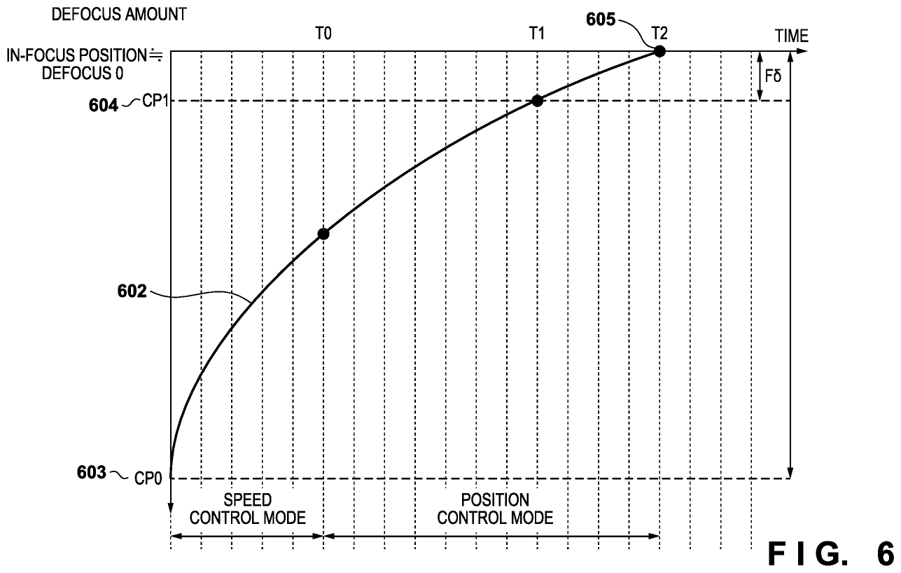

FIG. 6 is a diagram illustrating an example of a base curve, and indicates a part corresponding to a deceleration period (described later). The horizontal axis represents time, and the vertical axis represents the defocus amount. The upper-left is the origin, and corresponds to a defocus amount of 0 and a drive start time. Note that the defocus amount is converted according to the focus lens position, and the vertical axis can therefore be considered a relative lens position taking the in-focus position as a base point. Note that the defocus amount is assumed to be an absolute value.

Fδ in the figure indicates a focus range (depth of focus). F represents the aperture value, and δ represents the permissible circle of confusion diameter. The lens is in the in-focus state in a range of Fδ centered on the focus lens position where the defocus amount is 0. Here, the signs indicate the forward side and the back side. A focus lens position 604 corresponding to Fδ is represented by CPT.

A base curve 602 is designed such that the focus lens arrives at the in-focus position after progressing through an acceleration period, a constant speed period, and a deceleration period. The shape of the base curve 602 changes the manner in which the focus condition changes in response to movement of the focus lens, and thus the visual effects imparted on moving images differ. As such, reference drive characteristics for each visual effect are stored in the memory circuit 215.

Here, the calculation of a base curve having a longer deceleration period, which has the effect of slowly switching the subject in focus, will be described as an example.

Specifically, this base curve is as follows:
accelerated driving to reach a predetermined speed in a specified period (an acceleration period)
driving at a constant speed up to a position 603 (CPO) 100 Fδ from the in-focus position (a constant speed period)
decelerated driving from the position 603 and stopping at the in-focus position (a deceleration period)
   Note that the conditions for switching between each period may be changed.

Of the reference drive characteristics stored in the memory circuit 215, the camera control unit 212 reads out the reference drive characteristics that produce the corresponding effect. The base curve can then be calculated by scaling the reference drive characteristics according to the current defocus amount. Note that this method is merely an example, and the base curve may be calculated through another method.

As described above, FIG. 6 illustrates a part of the base curve 602 corresponding to the deceleration period. The slope of the base curve indicates the drive speed of the focus lens. Additionally, the vertical straight lines at equal intervals indicate the control period of the focus lens.

If it is possible to drive the focus lens to a target position (the in-focus position) along the base curve while keeping the drive speed at at least the minimum speed that can be realized by the speed control that can be specified (the minimum drive speed), the focus lens can be driven while adjusting the drive speed to follow the base curve. However, if the base curve has characteristics where the focus condition (defocus amount) changes gradually with decreased distance from the in-focus position, there will be a section where the speed cannot be kept at at least the minimum drive speed (a fine-driving section). In the fine-driving section, it is necessary to set a target position distanced from the current position by the minimum drive amount, and then repeatedly drive the focus lens by the minimum drive amount and stop the driving.

A mode in which the focus lens is not stopped until the final target position, and the focus lens is driven while adjusting the drive speed, will be called a “speed control mode”. When driving the focus lens according to the base curve, the driving can be performed in the speed control mode everywhere except the fine-driving section. On the other hand, a mode in which the focus lens is driven to the final target position while repeatedly driving the focus lens at the minimum drive amount and stopping the driving will be called a “position control mode”. When driving the focus lens according to the base curve, it is necessary to drive the focus lens in the position control mode in the fine-driving section.

In the example of the deceleration period illustrated in FIG. 6, it is assumed that the driving continues at the minimum drive amount from the position 603 (CPO) while reducing the drive speed, and that the drive speed reaches the minimum drive speed at time T0. In other words, the driving is in the speed control mode until time T0. On the other hand, the section from time T0 onward is the fine-driving section, and the driving therefore transitions to the position control mode. At time T1, the focus lens reaches a position 604 at a boundary of the focus range, and at time T2, furthermore reaches the in-focus position, where the driving stops. Although the focus lens is driven until reaching the in-focus position in this example, it should be noted that the driving may be stopped at any time after time T1, which is when the focus lens enters the focus range.

When the base curve is calculated in step S503, the camera control unit 212 stores the data of the base curve in, for example, the memory circuit 215 or the SDRAM 209, and ends the base curve calculation processing.

Returning to FIG. 4, in step S405, the camera control unit 212 performs focus lens drive mode determination processing. The “drive mode” is an operation mode pertaining to the drive speed, the target position, and driving timing of the focus lens. The camera control unit 212 determines the drive mode, among the plurality of drive modes, with which to drive the focus lens.

In step S406, the camera control unit 212 calculates, based on the base curve, control characteristics for actually controlling the driving of the focus lens according to the drive mode determined in step S405, and determines the drive speed, the target position, and the driving timing. The processing of step S405 and S406 will be described later in detail.

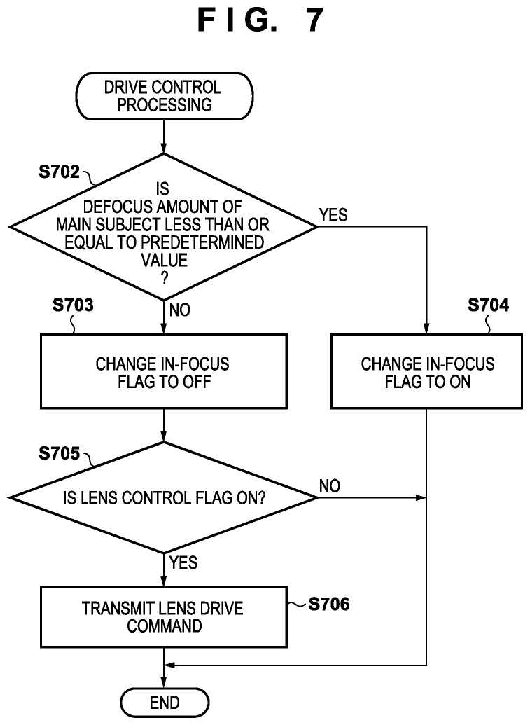

In step S407, the camera control unit 212 performs the drive control processing. The drive control processing performed in step S407 will be described in detail with reference to the flowchart in FIG. 7.

In step S702, the camera control unit 212 determines whether the defocus amount (absolute value) of the main subject obtained in step S403 is at least a predetermined value. The camera control unit 212 executes step S704 if the defocus amount is determined to be less than or equal to the predetermined value, and executes step S703 if not. Here, the predetermined value is, for example, a defocus amount corresponding to Fδ.

In step S704, the camera control unit 212 sets the “in-focus” flag stored in, for example, the SDRAM 209 to “on” (1) and ends the drive control processing. This is because if the main subject is in an in-focus state, there is no need to drive the focus lens.

In step S703, the camera control unit 212 changes the “in-focus” flag to “off” (0), and executes step S705.

In step S705, the camera control unit 212 determines whether a lens control flag, which is stored in, for example, the SDRAM 209, is on (1). The camera control unit 212 executes step S706 if the lens control flag is determined to be on, and ends the drive control processing if not. If the lens control flag is not on, i.e., is off, the focus lens control is not performed.

In step S706, the camera control unit 212 transmits, to the lens control unit 106, a lens drive command including the drive speed and the target position determined through step S406, and ends the drive control processing. Having received the lens drive command, the lens control unit 106 controls the focus lens drive unit 105 according to the drive speed and the target position included in the command, and drives the focus lens 103. This ends the AF processing illustrated in FIG. 4. The AF processing steps S401 to S408 are repeatedly executed every control period.

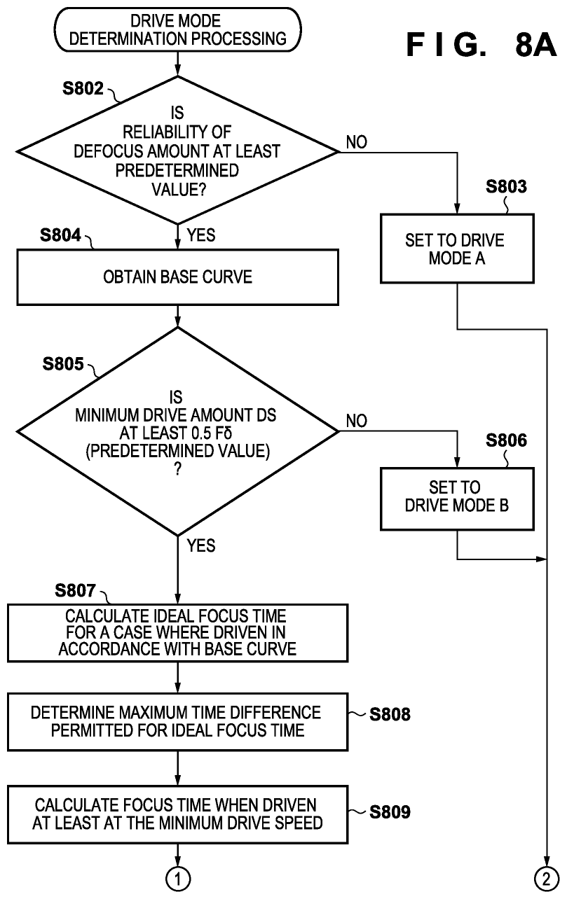

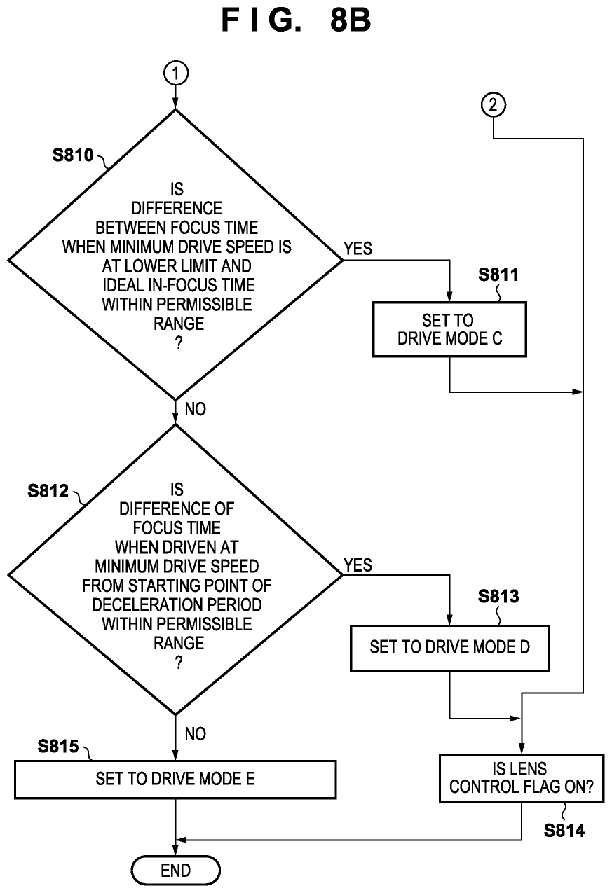

The drive mode determination processing in step S405 will be described in detail next with reference to the flowcharts in FIGS. 8A and 8B.

In step S802, the camera control unit 212 determines whether the reliability of the defocus amount of the main subject is at least a predetermined value. Like step S502, this determination may be made by comparing a reliability obtained from the AF signal processing unit 204 as the reliability of the amount of image shift used to calculate the defocus amount with the predetermined value. The magnitude of the predetermined value may be the same as in step S502, or different. The camera control unit 212 executes step S804 if the reliability of the defocus amount is determined to be at least the predetermined value, and executes step S803 if not.

In step S803, the camera control unit 212 determines a drive mode A for driving the focus lens to a position at which a defocus amount having a high reliability can be obtained, and then executes step S814.

In step S814, the camera control unit 212 sets the lens control flag to “on” and ends the drive mode determination processing.

In step S804, the camera control unit 212 obtains the base curve calculated in step S404 from the memory circuit 215 or the SDRAM 209, and then executes step S805.

In step S805, the camera control unit 212 determines whether the minimum drive amount of the focus lens is at least a predetermined value (e.g., a number of pulses corresponding to 0.5 Fδ). F may be, for example, the aperture value currently set, and δ may be, for example, the pixel pitch of the image sensor 201. Here, the minimum drive amount may be one of the aforementioned DS0 and DS1 (e.g., the greater of the two).

If the minimum drive amount is determined not to be at least the predetermined value, the camera control unit 212 executes step S806. A lens unit 10 in which the minimum drive amount is less than the predetermined value is considered to be suitable for fine driving through the position control mode. Accordingly, in step S806, the camera control unit 212 determines a drive mode B suitable for a lens unit which itself is suitable for fine driving.

In step S814, the camera control unit 212 sets the lens control flag to “on” and ends the drive mode determination processing.

On the other hand, if it is determined in step S805 that the minimum drive amount is at least the predetermined value, the camera control unit 212 executes step S807. A lens unit 10 in which the minimum drive amount is at least the predetermined value is considered not to be suitable for fine driving through the position control mode. Accordingly, the camera control unit 212 executes step S807 and the subsequent steps, and determines a drive mode B suitable for a lens unit 10 which itself is not suitable for fine driving.

In step S807, the camera control unit 212 calculates an ideal in-focus time for a case where the focus lens is driven using the base curve obtained in step S804. Here, the “ideal in-focus time” is a time period it takes for the focus lens to reach the in-focus position from when the position control mode is started, when the focus lens is driven according to the base curve. This corresponds to the length of time from time T0 to time T2 (the difference between time T2 and time T0) in the example in FIG. 6.

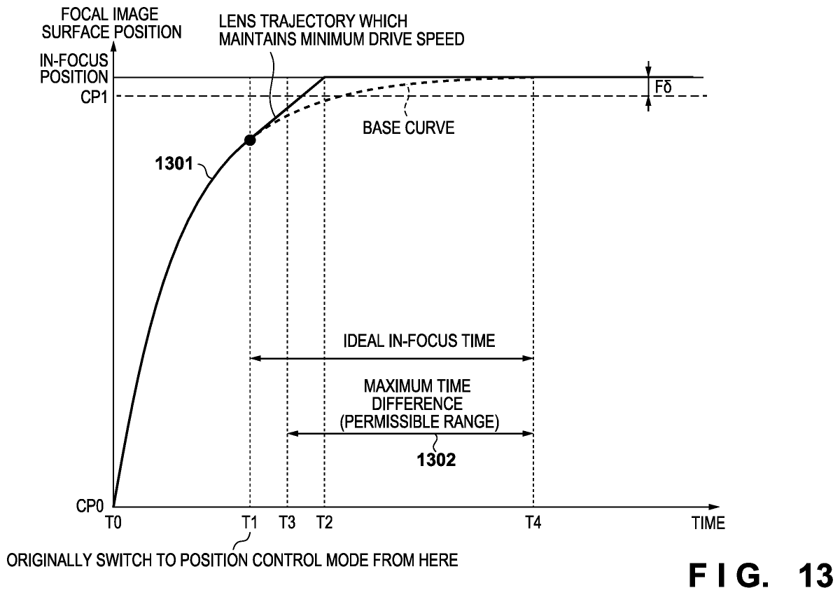

The processing of steps S808 to S811 will be described with reference to FIG. 13. FIG. 13 illustrates the deceleration period in a base curve 1301, in the same manner as in FIG. 6. Note that times T0 to T4 in FIG. 13 do not correspond to FIG. 6.

In step S808, the camera control unit 212 determines a maximum time difference permitted for the ideal in-focus time. Here, the maximum time difference is a difference between the ideal in-focus time and a minimum in-focus time that is a minimum time with which the focus lens can be driven to the in-focus position without any noticeable visual difference against the case in which the focus lens is driven to the in-focus position with the ideal in-focus time. This can be obtained experimentally using the ideal in-focus time as a reference, for example.

For example, in the example illustrated in FIG. 13, the ideal in-focus time corresponds to the length from time T1 to time T4 (T4−T1). On the other hand, the maximum time difference can be obtained as a predetermined percentage of (T4−T1). In FIG. 13, a maximum time difference 1302 is (T4−T3). Here, to avoid a situation in which the time required to in-focus is later than the ideal in-focus time, the longest in-focus time with which the focus lens can be driven to the in-focus position without any noticeable visual difference against the case in which the focus lens is driven to the in-focus position with the ideal in-focus time is not taken into account.

Next, in step S809, the camera control unit 212 calculates the time required to reach the in-focus position from time T1 when the focus lens 103 is driven at the minimum speed with the in-focus position as a target, while remaining in a speed-limited mode, even after passing time T1, where the mode should be switched to the position control mode. This corresponds to the length from time T1 to time T2 in FIG. 13 (T2−T1).

In step S810, the camera control unit 212 determines whether a in-focus time T2, when driving the focus lens at the minimum speed while remaining in the speed control mode even after time T1 where the mode should be switched to the position control mode, is within a permissible range for the in-focus time under ideal control. Specifically, if the sum of the time obtained in step S809 (T2−T1) and the maximum time difference found in step S808 (T4−T3) is at least the ideal in-focus time (T4−T1), the in-focus time T2 is determined by within the permissible range. Note that the in-focus time T2 may be determined to be within the permissible range when a difference between the time obtained in step S809 and the ideal in-focus time is less than the maximum time difference obtained in step S808.

The camera control unit 212 executes step S811 if it is determined that the difference from the in-focus time when performing ideal driving according to the base curve is within the permissible range even when driving to the in-focus position in the speed control mode, and executes step S812 if not.

In step S811, the camera control unit 212 determines a drive mode C.

In step S814, the camera control unit 212 sets the lens control flag to “on” and ends the drive mode determination processing.

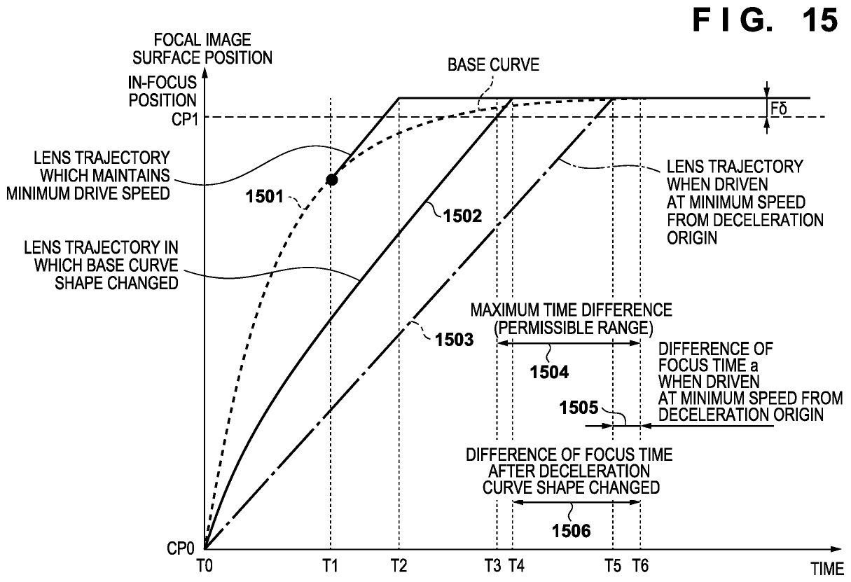

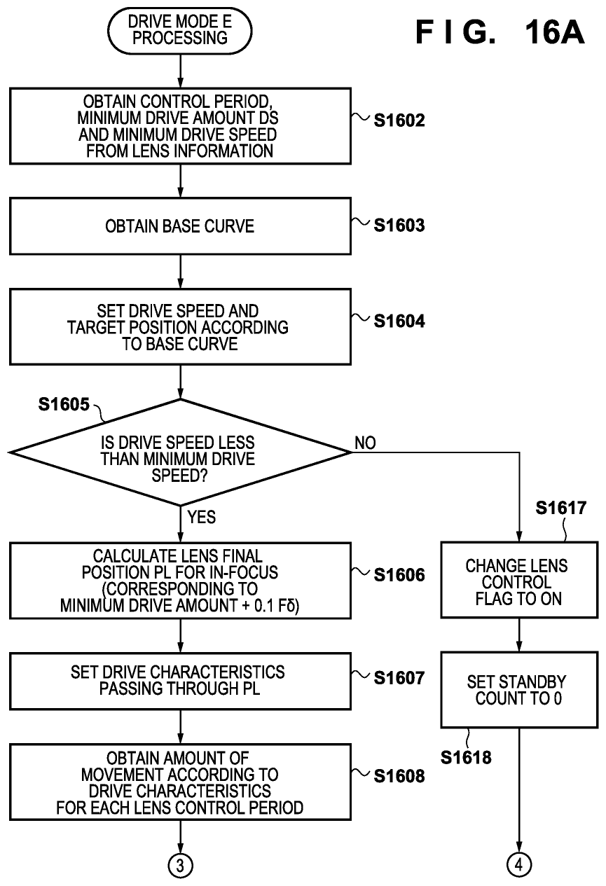

The processing of step S812 will be described with reference to FIG. 15. In step S812, the camera control unit 212 determines whether an in-focus time when the focus lens is driven while remaining at the minimum speed from the start of the deceleration period is within the permissible range for the in-focus time under ideal control. A maximum time difference 1504 defined by the permissible range uses the value determined in step S808, in the same manner as in step S810. However, for descriptive purposes, this is shorted than the maximum time difference 1302 illustrated in FIG. 13.

FIG. 15 illustrates the deceleration period in a base curve 1501. Time T0 is the start time of the deceleration period. An example is illustrated in which the in-focus time T2, when continuing to drive at the minimum drive speed remaining in the speed control mode even after time T1 where it is necessary to switch to the position control mode, is not within the permissible range for a in-focus time T5 under ideal control (time T3−T5). In such a case, in step S812, the camera control unit 212 examines whether changing the start time of the driving at the minimum drive speed to time T0 will bring the in-focus time into the permissible range (or whether a difference from the in-focus time will be within the permissible range).

1503 indicates a lens trajectory when the starting driving at the minimum drive speed from the start time T0 of the deceleration period of the base curve 1501. In this case, the focus lens reaches the in-focus position at time T5. Time T5 is within the permissible range (time T3 to time T6) of the in-focus time T6 under ideal control according to the base curve.

In this manner, if an in-focus time within the permissible range can be achieved by starting driving at the minimum drive speed from the start time T0 of the deceleration period in the base curve 1501, it is thought that characteristics similar to the base curve 1501 can be realized while maintaining the speed control mode. The camera control unit 212 executes step S813 if it is determined that changing the start time of the driving at the minimum drive speed to time T0 will make it possible to bring the in-focus time into the permissible range.

In step S813, the camera control unit 212 determines a drive mode D.

In step S814, the camera control unit 212 sets the lens control flag to “on” and ends the drive mode determination processing.

On the other hand, if an in-focus time within the permissible range cannot be achieved even when starting driving at the minimum drive speed from the start time T0 of the deceleration period in the base curve 1501, it is thought that characteristics similar to the base curve 1501 cannot be realized while maintaining the speed control mode. The camera control unit 212 executes step S815 if it is not determined that changing the start time of the driving at the minimum drive speed to time T0 will make it possible to bring the in-focus time into the permissible range.

In step S815, the camera control unit 212 determines a drive mode E, and ends the drive mode determination processing.

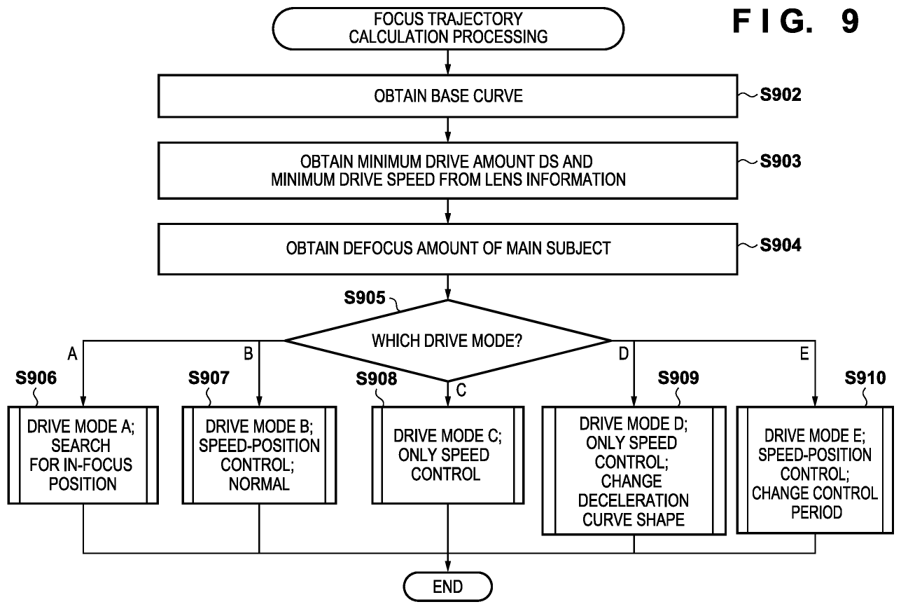

The focus trajectory calculation processing in step S406 will be described in detail next with reference to the flowchart in FIG. 9.

In step S902, the camera control unit 212 obtains a base curve in the same manner as in step S804. If the base curve obtained in step S804 remains, that base curve may be used.

In step S903, the camera control unit 212 obtains the minimum drive amount DS and the minimum drive speed from the lens information obtained in the startup processing. The minimum drive amount DS is assumed to be one of DS0, obtained from the lens unit, and DS1, obtained in the lens reset operation (e.g., the greater of the two).

In step S904, the camera control unit 212 obtains the defocus amount for the main subject calculated in step S403. This may be calculated anew in step S904.

In step S905, the camera control unit 212 finds the drive mode determined in the drive mode determination processing. The camera control unit 212 executes step S906 if the drive mode A is determined; step S907, if the drive mode B is determined; step S908, if the drive mode C is determined; step S909, if the drive mode D is determined; and step S910, if the drive mode E is determined.

Drive Mode A

The processing of step S906 will be described with reference to the flowchart illustrated in FIG. 10. The drive mode A is determined when the reliability of the defocus amount of the main subject is less than the predetermined value. Accordingly, in the drive mode A, operations are performed according to the reliability of the defocus direction.

In step S1002, the camera control unit 212 determines whether the reliability of the defocus direction detected for the main subject is at least a predetermined value. The reliability of the defocus direction is communicated to the camera control unit 212 from the AF signal processing unit 204 along with the reliability of the amount of image shift. The camera control unit 212 executes step S1003 if the reliability of the defocus direction is determined to be at least the predetermined value (is reliable), and executes step S1004 if not.

In step S1003, of both ends of the drivable range of the lens, the camera control unit 212 sets the end of the defocus direction as the target position, and ends the processing of the drive mode A. If the reliability of the defocus direction is high, the in-focus position is searched for by driving the focus lens in the direction that increases the reliability.

In step S1004, of both ends of the drivable range of the lens, the camera control unit 212 sets the end at a longer distance from the current position of the focus lens (the further end) as the target position, and ends the processing of the drive mode A. If the reliability of the defocus direction is not high, an in-focus position having a high reliability is searched for over a broader range.

Drive Mode B

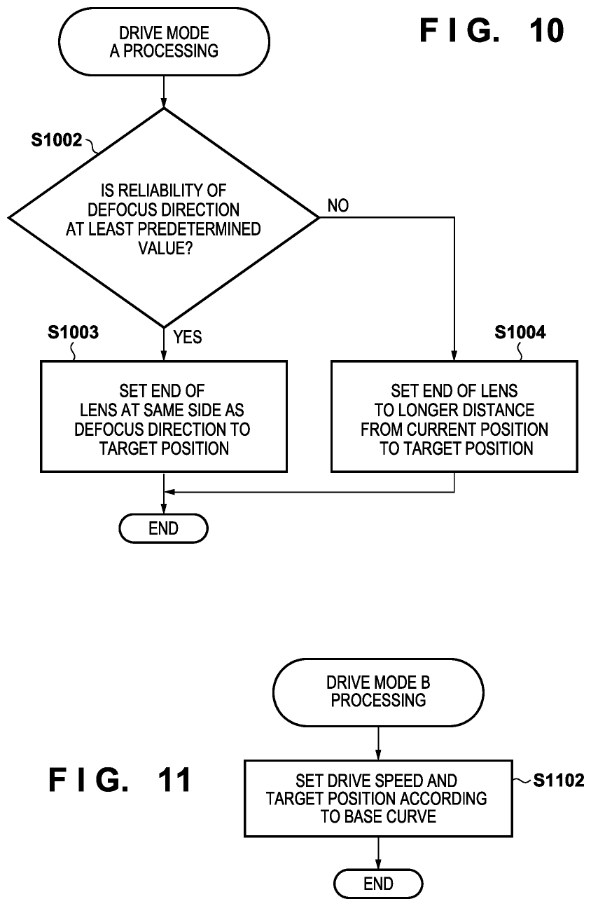

The processing of step S907 will be described with reference to the flowchart illustrated in FIG. 11. The drive mode B is determined for a lens unit considered to be suitable for fine driving. Accordingly, in the drive mode B, the focus lens is driven such that the drive characteristics indicated by the base curve are realized.

In step S1102, the camera control unit 212 sets the drive speed and the target position according to the base curve, and ends the drive mode B processing.

Drive Mode C

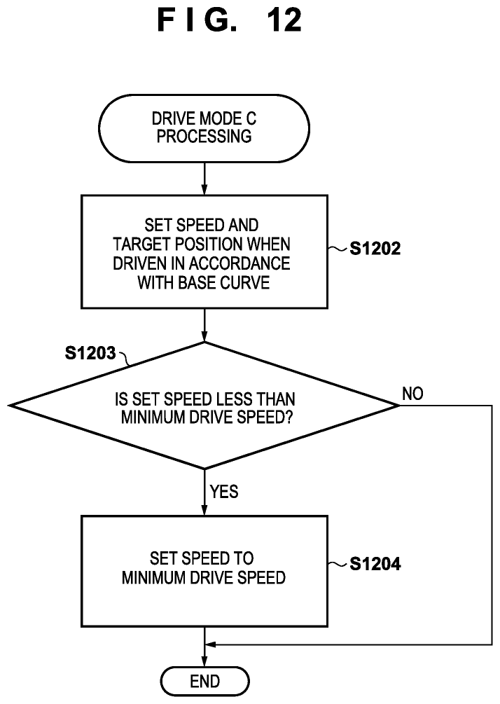

The processing of step S908 will be described with reference to the flowchart illustrated in FIG. 12. The drive mode C is determined for a lens unit considered to be unsuitable for fine driving. Accordingly, in the drive mode C, the focus lens is continually driven only in the speed control mode (while staying at at least the minimum drive speed), while prioritizing the drive characteristics of the base curve.

In step S1202, the camera control unit 212 sets the drive speed and the target position according to the base curve.

In step S1203, the camera control unit 212 determines whether the drive speed set in step S1202 is less than the minimum drive speed, executes step S1204 if so, and ends the drive mode C processing if not.

In step S1204, the camera control unit 212 changes the drive speed to the minimum drive speed. The target position remains unchanged at the in-focus position. Through this, the speed control mode is maintained even after time T1 in FIG. 13, and the focus lens is driven as indicated by the solid line. The camera control unit 212 then ends the processing in the drive mode C.

Drive Mode D

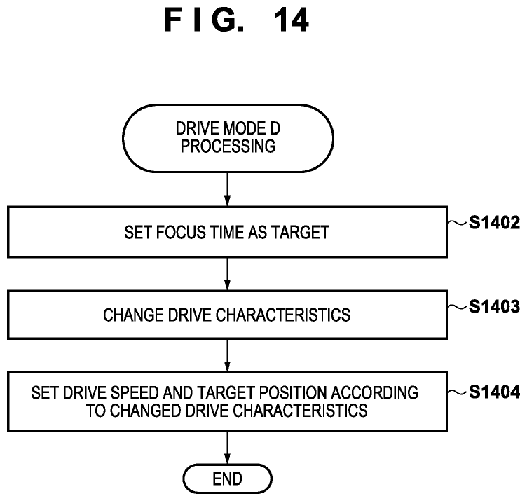

The processing of step S909 will be described with reference to the flowchart illustrated in FIG. 14. The drive mode D is determined when, for a lens unit considered to be unsuitable for fine driving, the difference from the ideal in-focus time does not fall within the permissible range (i.e., exceeds the permissible range) in the drive mode C. Accordingly, in the drive mode D, the focus lens is driven only in the speed control mode (while staying at at least the minimum drive speed) by changing the drive characteristics of the deceleration period in the base curve.

In step S1402, the camera control unit 212 sets a target in-focus time. The drive mode D is determined when an in-focus time within the permissible range can be realized with respect to the ideal in-focus time when the focus lens is driven at the minimum drive speed from the starting point of the deceleration period in step S812.

In the example of FIG. 15, this corresponds to the in-focus time T5, when the focus lens is driven at the minimum drive speed from time T0, being within the permissible range with respect to the ideal in-focus time T6 (time T3 to T6). If instead of linear drive characteristics (lens trajectory) 1503 that drives at the minimum drive speed from time T0, the drive characteristics are transformed to be similar to the base curve 1501, the in-focus time will be earlier than time T5. Accordingly, the camera control unit 212 can set the target in-focus time to be within the range from time T3 to time T5. Assume, as an example, that time T4 is set as the target in-focus time.

In step S813, the camera control unit 212 changes the drive characteristics of the deceleration period in the base curve. For example, the camera control unit 212 sets a given time (Tx) from the start time T0 of the deceleration period to the target in-focus time T4 as the start time of constant speed driving at the minimum drive speed. Then, taking a section from time T0 to time Tx as a deceleration drive section down to the minimum drive speed, the camera control unit 212 sets drive characteristics that take the section from time Tx to time T4 as a constant speed driving section at the minimum drive speed. 1502 in FIG. 15 indicates an example of the drive characteristics after the change.

Note that the drive characteristics are only changed in the deceleration period of the base curve, and the base curve is maintained in the acceleration period and the constant speed period therebefore. Additionally, time Tx may also be set to time T0, in which case the drive speed is faster than the minimum drive speed. Furthermore, the target in-focus time may be set to T5, and constant speed driving may be performed at the minimum drive speed from time T0 (using the drive characteristics indicated by 1503).

In step S1404, the camera control unit 212 sets the drive speed and the target position according to the post-change drive characteristics, and ends the drive mode D processing.

Drive Mode E

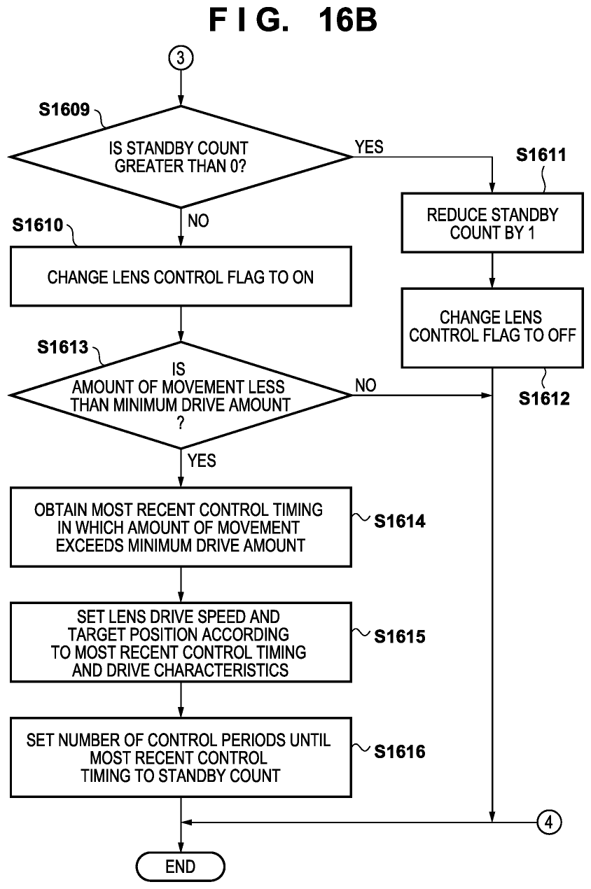

The processing of step S910 will be described with reference to the flowcharts illustrated in FIGS. 16A and 16B. The drive mode E is determined when, for a lens unit considered to be unsuitable for fine driving, the difference from the ideal in-focus time does not fall within the permissible range (i.e., exceeds the permissible range) in the drive mode C and the drive mode D. Accordingly, in the drive mode E, driving at less than the minimum drive speed in the speed control mode is realized simulatively by controlling the interval at which the lens drive command is transmitted.

In step S1602, the camera control unit 212 obtains the lens information. Note that the lens information obtained in the startup processing may be used, or the lens information may be obtained again. The minimum drive amount DS is assumed to be one of DS0 and DS1 (e.g., the greater of the two). Here, the minimum drive speed of the focus lens is assumed to be the same as the image plane speed (movement speed of the image formation surface), which is 10 mm/sec. Furthermore, the control period is assumed to be 1/60, synchronized to the moving image framerate.

Note that for the minimum drive amount DS, the camera control unit 212 converts a value in units of the drive pulse of the focus lens into a value in units of the depth of focus Fδ. Specifically, the physical drive amount expressed as a number of pulses is converted into an amount of movement of the image plane using the sensitivity of the lens image plane, and is then divided by the current aperture value (F2) and the allowable circle of confusion diameter to calculate a value expressed as DSFδ. DSFδ is an indicator of the minimum drive amount required to move the focus lens.

In step S1603, the camera control unit 212 obtains a base curve. Abase curve already obtained from other processing may be used again.

In step S1604, the camera control unit 212 sets the drive speed and the target position according to the base curve.

In step S1605, the camera control unit 212 determines whether the drive speed set in step S1604 is less than the minimum drive speed, executes step S1606 if so, and executes step S1617 if not.

In step S1617, the camera control unit 212 sets the lens control flag to “on” and then executes step S1618.

In step S1618, the camera control unit 212 sets the standby count (described later), which is a variable stored in the SDRAM 209, for example, to 0, and ends the drive mode E processing.

In steps S1606 to S1609, the camera control unit 212 calculates the drive characteristics for the fine-driving section. The fine-driving section is a section in which drive speed less than the minimum drive speed is required in the speed control mode, and which conventionally is driven in the position control mode.

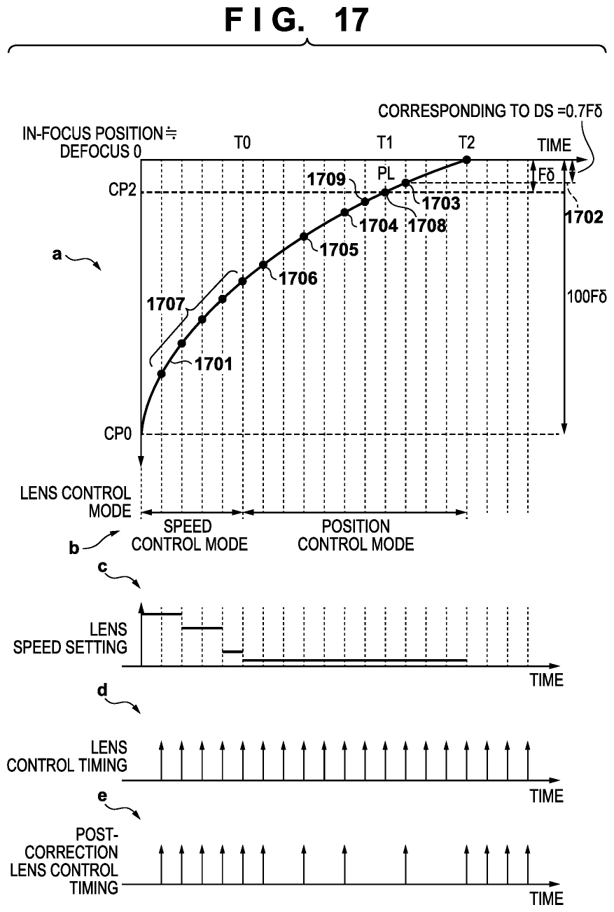

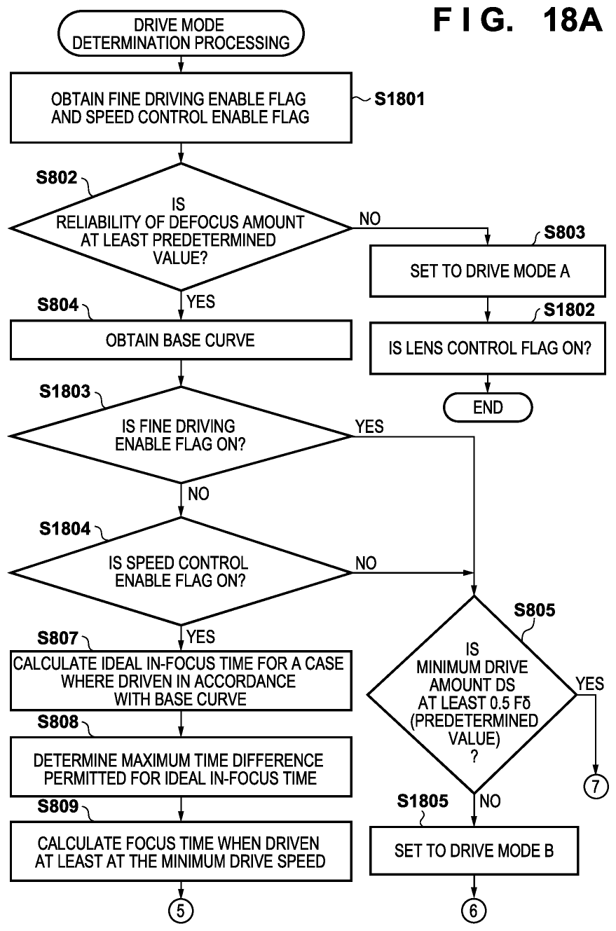

Focus trajectory calculation processing in the fine-driving section will be described with reference to FIG. 17.

FIG. 17 is a diagram illustrating the processing from step S1606 to step S1609, with respect to the base curve illustrated in FIG. 6. In a, CP2 indicates a defocus amount corresponding to the depth of focus Fδ. The minimum drive amount DS is assumed to be 0.7 Fδ. A dotted line 1702 indicates a defocus amount corresponding to 0.7 Fδ. Additionally, b indicates the lens drive mode, and c indicates the drive speed per control period. Until time T0, the focus lens is driven while decelerating in the speed control mode, and from time T0, the focus lens is driven in the position control mode at the minimum drive speed.

In step S1606, the camera control unit 212 calculates a lens position PL immediately before the in-focus state. The position PL is the lens position when the drive command is last transmitted. Here, a lens position corresponding to a defocus amount (0.8 Fδ), which is obtained by adding an offset amount of 0.1 Fδ to the minimum drive amount DS, is taken as the last lens position PL. Accordingly, the camera control unit 212 calculates a point where the defocus amount is 0.8 Fδ at the timing of the control period, on or near the base curve. 1703 indicates the calculated position PL.

In step S1607, the camera control unit 212 sets, based on the base curve, drive characteristics 1701 passing through the position PL.

In step S1608, the camera control unit 212 calculates an amount of movement per control period. In FIG. 17, a lens control timing indicated in d corresponds to the vertical lines in a. The control timing corresponds to the start time of the control period, and the camera control unit 212 normally transmits a drive command to the lens control unit 106 periodically according to the control timing. A difference in the vertical axis coordinates of the intersection of the two adjacent vertical lines and the control characteristics 1701 indicates the amount of movement of the focus lens in the control period defined by the two vertical lines.

In steps S1609 to S1616, processing for modifying the control timing is performed by excluding control timings in control periods where the amount of movement of the focus lens is lower than the minimum drive amount DS.

In the control characteristics 1701, a control timing one previous to the control timing corresponding to a position 1703 is a position 1708. However, the amount of movement from the position 1708 to 1703 is less than the minimum drive amount DS, and thus the control timing corresponding to the position 1708 is excluded. Furthermore, the amount of movement from a position 1709, which is one period previous, to 1703 is of course less than the minimum drive amount DS, and thus the control timing corresponding to the position 1709 is excluded as well.

The amount of movement from a position 1704, which is yet another period previous, to 1703 is greater than the minimum drive amount DS, and thus the control timing corresponding to the position 1704 is maintained. Likewise, the control timings corresponding to positions 1706 and 1707 are maintained, but the control timing between positions 1704 and 1705, and the control timing between positions 1705 and 1706, are excluded.

The control timing modified in this manner is indicated in e of FIG. 17. In this manner, by thinning out the control timings of control periods in which the drive amount is less than the minimum drive amount DS, a drive amount that is greater than the minimum drive amount DS can be specified at each control timing. The camera control unit 212 does not transmit lens drive commands to the lens control unit 106 in the control periods in which the control timings have been thinned out.

The processing of each step will be described hereinafter.

In step S1609, the camera control unit 212 determines whether the standby count is greater than 0, executes step S1611 if so, and executes step S1610 if not. The standby count being greater than 0 indicates that the control timing being processed is being thinned out. Accordingly, the camera control unit 212 stops driving the focus lens.

In step S1611, the camera control unit 212 reduces the standby count by 1.

In step S1612, the camera control unit 212 sets the lens control flag to “off” and ends the drive mode E processing.

On the other hand, the standby count not being greater than 0 (i.e., being 0) indicates that the control timing being processed is not being thinned out. Accordingly, the camera control unit 212 performs processing for driving the focus lens.

In step S1610, the camera control unit 212 changes the lens control flag to “on” and then executes step S1613.

In step S1613, the camera control unit 212 determines whether the amount of movement obtained in step S1608 is less than the minimum drive amount, executes step S1614 if so, and ends the drive mode E processing if not.

If the amount of movement is less than the minimum drive amount, the focus lens is not driven at the control timing being processed, and it is necessary to wait until the control timing when it becomes possible to specify an amount of movement greater than the minimum drive amount. Accordingly, in step S1614, the camera control unit 212 sequentially adds the amount of movement of the subsequent control periods to the amount of movement obtained in step S1608, and detects the most recent control timing at which the total is at least the minimum drive amount.

In step S1615, the camera control unit 212 sets the drive speed and the target position to be specified for the control timing detected in step S1614. The target position is a position distanced from the current position by the amount of movement added in step S1614. The drive speed may be the minimum drive speed.

In step S1616, the camera control unit 212 sets the number of control periods to wait until the control timing detected in step S1614 in the standby count, and ends the drive mode E processing.

By setting the target position and the drive speed as described above, driving at the minimum drive speed makes it possible to effectively realize driving in which the drive amount per control period is less than the minimum drive amount.

According to the present embodiment, the drive method is changed according to the focus lens drive characteristics of the lens unit for the fine-driving section, in which it is necessary to drive the focus lens in the position control mode to realize the ideal drive characteristics determined in advance. Specifically, for a lens unit determined to be unsuitable for fine driving of the focus lens, the focus lens is driven in the speed control mode instead of the position control mode for the fine-driving section.

When driving is performed in position control mode in the fine-driving section, it is necessary to repeatedly drive and stop the focus lens. Accordingly, driving a lens unit that is unsuitable for fine driving in the position control mode will cause a delay in the time until the image comes into focus. On the other hand, in speed control mode, the focus lens is not stopped until the focus lens reaches the in-focus position, which makes it possible to prevent a delay in in-focus time.

By driving the focus lens in the speed control mode in the fine-driving section, the amount of focus lens movement per unit of time is greater than when driving in the position control mode, resulting in faster focusing than with the ideal drive characteristics. If the difference between the in-focus time when driving in the speed control mode in the fine-driving section and the in-focus time from the ideal drive characteristics exceeds a permissible range, the ideal drive characteristics are changed such that the focus lens can be driven only in the speed control mode, in order to bring the difference in in-focus times within the permissible range. This makes it possible to prevent delays in focusing without greatly changing the visual effect of the moving image.

### Second Embodiment

A second embodiment of the present invention will be described next. The second embodiment is the same as the first embodiment with the exception of the drive mode determination processing (FIGS. 8A and 8B), and thus the following descriptions will focus on the differences in the drive mode determination processing.

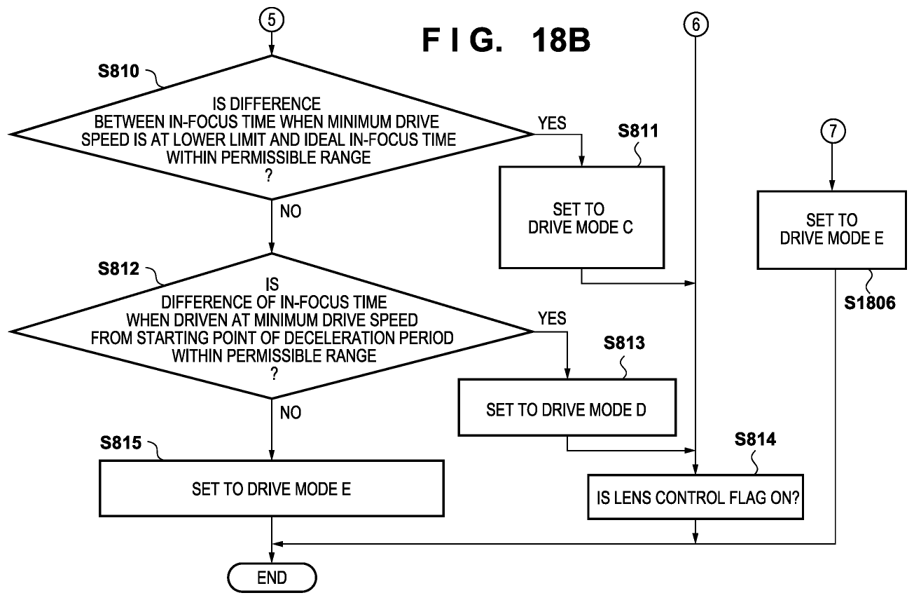

FIGS. 18A and 18B are flowcharts 4 illustrating the drive mode determination processing according to the present embodiment. Steps carrying out the same processes as those in the first embodiment will be given the same reference signs, and descriptions thereof will be omitted. Additionally, the processing of the determined drive mode may be the same as in the first embodiment, and will therefore not be described.

In step S1801, the camera control unit 212 obtains a fine driving enable flag and a speed control enable flag. These flags may be obtained from the lens unit 10 as lens information, or the type information and the values of these flags may be associated and stored in the ROM 210, for example, and then obtained by referring to the ROM 210 based on the type information of the mounted lens unit.

The fine driving enable flag is a flag indicating whether the lens unit is suitable for fine driving. For example, for a lens unit that is not suitable for fine driving, such as, for example, a type of lens unit that uses a DC motor to drive a large focus lens (e.g., a large-format cinema lens), the fine driving enable flag is set to “off”.

The speed control enable flag, for example, is set to “off” for lens units not expected to undergo focus lens driving in the speed control mode (i.e., which does not support a drive command specifying drive speed).

Steps S802 to S804 are the same processing as in the first embodiment.

After obtaining the base curve in step S804, in step S1803, the camera control unit 212 determines whether the fine driving enable flag is “on”, executes step S806 if so, and executes step S1804 if not. A lens unit for which the fine driving enable flag is set to “on” is considered to be capable of driving according to the base curve using the position control mode.

In step S1804, the camera control unit 212 determines whether the speed control enable flag is “on”. If the speed control enable flag is determined to be “on”, driving in the speed control mode is not possible, and thus the camera control unit 212 executes step S807. The processing after step S807 is the same as in the first embodiment.

On the other hand, if the speed control enable flag is determined not to be “on”, drive modes D and E, which use the speed control mode, cannot be applied, and thus the camera control unit 212 executes step S806.

In step S805, the camera control unit 212 determines whether the minimum drive amount DS is at least a predetermined value (at least 0.5 Fδ).

If the minimum drive amount is determined not to be at least the predetermined value, the camera control unit 212 executes step S1805. A lens unit 10 in which the minimum drive amount is less than the predetermined value is considered to be suitable for fine driving through the position control mode. Accordingly, in step S1805, the camera control unit 212 determines a drive mode B suitable for a lens unit which itself is suitable for fine driving.

In step S814, the camera control unit 212 sets the lens control flag to “on” and ends the drive mode determination processing.

On the other hand, if it is determined in step S805 that the minimum drive amount is at least the predetermined value, the camera control unit 212 executes step S1806. A lens unit 10 in which the minimum drive amount is at least the predetermined value is considered not to be suitable for fine driving through the position control mode. Accordingly, in step S1806, the camera control unit 212 determines the drive mode E, and ends the drive mode determination processing.

As described above, according to the second embodiment, control is performed using a modified branching of modes. Although the mode branching is implemented according to the fine driving enable flag and the speed control enable flag obtained from the lens in this example, the branching conditions for each mode may be changed as necessary.

### Other Embodiments

The foregoing embodiments have described a configuration in which the defocus amount is detected by the image plane phase difference detection method. However, the present invention can also be applied in a configuration in which a dedicated phase detection sensor is used to detect the defocus amount.

In addition, in the foregoing embodiments, whether the lens unit is suitable for fine driving was determined based on the magnitude of the minimum drive amount and the fine driving enable flag. However, it is also possible to determine whether a lens unit is suitable for fine driving based on other criteria. The following are possible examples.

A delay time from when the drive command is transmitted to when the focus lens starts moving (if at least a predetermined time, the lens is not suitable for fine driving).

A delay time from when the drive command is transmitted to when the focus lens starts moving/a time from when the drive command is transmitted to when the focus lens reaches a specified speed (if at least a predetermined time, the lens is not suitable for fine driving).

An actual amount of movement from when the drive command is transmitted to when the focus lens reaches a specified speed/an ideal amount of movement from when the drive command is transmitted to when the focus lens reaches a specified speed (if less than a predetermined amount of movement, the lens is not suitable for fine driving).

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-050386, filed on Mar. 24, 2021, which is hereby incorporated by reference herein in its entirety.

What is claimed is:

1. A focus adjustment device that controls driving of a focus lens included in a lens unit during moving image shooting, the focus adjustment device comprising one or more processors that execute a program and thereby function as:
an obtainment unit that obtains a drive pattern determined in advance for driving the focus lens to an in-focus position; and
a control unit that controls the driving of the focus lens,
wherein if the drive pattern has a fine-driving section in which it is necessary to drive the focus lens at a drive speed less than a minimum drive speed set in advance, and it is determined that the lens unit not to be suitable for fine driving of the focus lens, the control unit continuously drives the focus lens at the minimum drive speed in the fine-driving section.

2. The focus adjustment device according to claim 1,
wherein if the drive pattern has the fine-driving section and it is determined that the lens unit to be suitable for fine driving of the focus lens, the control unit repeatedly executes fine driving of the focus lens in the fine-driving section.

3. The focus adjustment device according to claim 1,
wherein for the fine-driving section, if a difference between (i) a time at which the focus lens reaches the in-focus position by continuously driving the focus lens at the minimum drive speed and (ii) a time at which the focus lens reaches the in-focus position by driving the focus lens according to the drive pattern exceeds a permissible range set in advance, the control unit changes the drive pattern and continuously drives the focus lens at the minimum drive speed from a point in time based on the drive pattern after the change so that the difference to be within the permissible range.

4. The focus adjustment device according to claim 3,
wherein if the difference exceeds the permissible range even after changing the drive pattern or if the lens unit does not support a drive command specifying a drive speed of the focus lens, in the fine-driving section, the control unit changes an interval at which the drive command of the focus lens is transmitted such that the focus lens can be driven using a drive command specifying a drive amount that is not less than a minimum drive amount of the focus lens.

5. The focus adjustment device according to claim 4,
wherein the control unit changes the interval by skipping transmitting the drive command of the focus lens at a control timing, among periodic control timings set in advance, at which an amount of movement of the focus lens until a next control timing is less than the minimum drive amount of the focus lens.

6. The focus adjustment device according to claim 1,
wherein the control unit determines whether the lens unit is suitable for fine driving based on a minimum drive amount of the focus lens.

7. The focus adjustment device according to claim 6,
wherein the minimum drive amount is a minimum drive amount obtained from the lens unit.

8. The focus adjustment device according to claim 6,
wherein the minimum drive amount is a minimum drive amount obtained during a reset operation of the lens unit.

9. The focus adjustment device according to claim 1,
wherein the control unit determines whether the lens unit is suitable for fine driving based on the information obtained from the lens unit.

10. The focus adjustment device according to claim 9,
wherein the information is information indicating whether the lens unit is suitable for fine driving, the information being associated with the lens unit in advance.

11. An image capture apparatus comprising:
a defocus amount obtainment unit that obtains a defocus amount of a lens unit that is mounted; and
a focus adjustment device that drives a focus lens included in the lens unit based on the defocus amount,
wherein the focus adjustment device comprising:
an obtainment unit that obtains a drive pattern determined in advance for driving the focus lens to an in-focus position; and
a control unit that controls the driving of the focus lens,
wherein if the drive pattern has a fine-driving section in which it is necessary to drive the focus lens at a drive speed less than a minimum drive speed set in advance, and it is determined that the lens unit not to be suitable for fine driving of the focus lens, the control unit continuously drives the focus lens at the minimum drive speed in the fine-driving section.

12. A focus adjustment method executed by a focus adjustment device for controlling driving of a focus lens having a lens unit during moving image shooting, the focus adjustment method comprising:
obtaining a drive pattern determined in advance for driving the focus lens to an in-focus position; and
controlling the driving of the focus lens,
wherein when the drive pattern has a fine-driving section in which it is necessary to drive the focus lens at a drive speed less than a minimum drive speed set in advance, and the lens unit is determined not to be suitable for fine driving of the focus lens, the controlling includes continuously driving the focus lens at the minimum drive speed in the fine-driving section.

13. A non-transitory computer-readable medium storing a program that causes a computer to function as a focus adjustment device comprising:
an obtainment unit that obtains a drive pattern determined in advance for driving the focus lens to an in-focus position; and
a control unit that controls the driving of the focus lens,
wherein if the drive pattern has a fine-driving section in which it is necessary to drive the focus lens at a drive speed less than a minimum drive speed set in advance, and it is determined that the lens unit not to be suitable for fine driving of the focus lens, the control unit continuously drives the focus lens at the minimum drive speed in the fine-driving section.
